(19) United States
(12) Patent Application Publication
(10) Pub. No.: US 2020/0050741 A1
(43) Pub. Date: Feb. 13, 2020

(54) METHOD FOR RIGHTS MANAGEMENT, SYSTEM FOR RIGHTS MANAGEMENT, READABLE STORAGE MEDIUM, AND COMPUTER DEVICE

(71) Applicant: BOE TECHNOLOGY GROUP CO., LTD., Beijing (CN)

(72) Inventors: Siyu ZHU, Beijing (CN); Litong HAN, Beijing (CN)

(21) Appl. No.: 16/392,568

(22) Filed: Apr. 23, 2019

(30) Foreign Application Priority Data
Aug. 9, 2018 (CN) 201810904921.9

(51) Int. Cl. G06F 21/16; H04L 9/06; H04L 9/32

(52) U.S. Cl. CPC G06F 21/16; H04L 2209/38; H04L 9/3236; H04L 9/0637

(57) ABSTRACT

A method for rights management includes acquiring rights-related information of a first work for a rights holder; constructing the rights-related information of the first work into a block, saving the block into a first blockchain, and issuing the rights-related information to a network storing the first blockchain; storing the work identifier and a block identifier of the block where the rights-related information is located; receiving an authentication request exhibiting the first work, the authentication request including the work identifier of the first work; and searching the block identifier of the block where the rights-related information of the first work is according to the authentication request and generating an exhibition determination instruction according to the block identifier and the work identifier.

### CROSS REFERENCE TO RELATED APPLICATIONS

This application is based upon, and claims the benefit of and priority to, Chinese Patent Application No. 201810904921.9, filed on Aug. 9, 2018, the entire contents thereof being incorporated herein by reference.

### TECHNICAL FIELD

The present disclosure relates to the field of digital rights management (DRM), and more particularly, to a method for rights management, a system for rights management, a readable storage medium, and a computer device.

### BACKGROUND

Online artwork rights management is mainly for digital rights based on player terminals, for example, digital paintings, pictures, photographic works, and videos, etc.

Generally, digital rights holders authorize the digital rights to platform providers, such that the platform providers may authorize individual users to play back or exhibit works by way of membership sales, where license agreements between the digital rights holders and the platform providers generally include time limits. For example, the platform providers are authorized with two years of permissions. At this moment, the digital rights holders need to know whether the platform providers or users view the works beyond an authorization period and, by using blockchain technologies, the digital rights holders may indirectly control playback behaviors of the terminal users. In this case, there may be two problems. First, the platform providers still provide overdue exhibition or permit the users to exhibit the works. Second, the individual users still exhibit the works beyond the authorized period.

### BRIEF SUMMARY OF INVENTION

An embodiment of the present disclosure provides a method for rights management, which includes:

acquiring rights-related information of a first work for a rights holder, the rights-related information comprising authorization period information and a work identifier of the first work;

constructing the rights-related information of the first work into a block, saving the block into a first blockchain, and issuing the rights-related information to a network storing the first blockchain;

storing the work identifier and a block identifier of the block where the rights-related information is located;

receiving an authentication request exhibiting the first work, the authentication request including the work identifier of the first work; and

searching the block identifier of the block where the rights-related information of the first work is located according to the authentication request, and generating an exhibition determination instruction according to the block identifier and the work identifier.

Further, the authentication request also includes platform authorization period information on the first work for a platform provider.

The generating an exhibition determination instruction according to the block identifier and the work identifier includes:

obtaining the authorization period information in the first blockchain according to the block identifier and the work identifier, determining whether the authorization period information is greater than the platform authorization period information, and generating a permission exhibition determination instruction in response to the authorization period information being greater than the platform authorization period information, or generating a rejection exhibition determination instruction in response to the authorization period information being not greater than the platform authorization period information.

In an exemplary embodiment, the method includes:

constructing indicated content information into a block, saving the block into a second blockchain, and issuing the indicated content information to a network storing the second blockchain, the indicated content information comprising the exhibition determination instruction, the work identifier, and exhibition terminal information; and

storing the work identifier, the exhibition terminal information, and the block identifier of the block where the indicated content information is located.

In an exemplary embodiment, the method also includes:

obtaining indicated content update information, the indicated content update information comprising the exhibition determination instruction, the work identifier, and the exhibition terminal information;

determining whether the exhibition determination instruction corresponding to the same work identifier and the same exhibition terminal information is changed according to the indicated content update information and the indicated content information, and generating a prompt instruction in response to the exhibition determination instruction being changed; and

updating the stored block identifier of the block where the indicated content information is located to be a block identifier of a block where a content included in the indicated content update information is located.

In an exemplary embodiment, the method also includes: searching the stored exhibition terminal information and the block identifier of the block where the indicated content information is located according to the work identifier of the query instruction;

obtaining an exhibition determination instruction in the second blockchain according to the block identifier, the work identifier and the exhibition terminal information; and

generating exhibition information including the work identifier, the exhibition terminal information and the exhibition determination instruction.

An embodiment of the present disclosure provides a system for rights management, which includes a first blockchain processing apparatus and a playback permission authentication apparatus. The first blockchain processing apparatus includes a rights-related information acquiring module, a first blockchain generating and issuing module, and a first storage module. The playback permission authentication apparatus includes an authentication request receiving module and an exhibition determination instruction generating module.

The rights-related information acquiring module is configured to acquire rights-related information of a first work for a rights holder, where the rights-related information includes authorization period information and a work identifier of the first work.

The first blockchain generating and issuing module is configured to construct the rights-related information of the first work into a block, save the block into a first blockchain, and issue the rights-related information to a network storing the first blockchain.

The first storage module is configured to store the work identifier and a block identifier of the block where the rights-related information is located.

The authentication request receiving module is configured to receive an authentication request exhibiting the first work, where the authentication request includes the work identifier of the first work.

The exhibition determination instruction generating module is configured to search the block identifier of the block where the rights-related information of the first work is located according to the authentication request, and generate an exhibition determination instruction according to the block identifier and the work identifier.

In an exemplary embodiment, the authentication request also includes platform authorization period information on the first work for a platform provider.

The generating, by the exhibition determination instruction generating module, an exhibition determination instruction according to the block identifier and the work identifier includes:

obtaining, by the exhibition determination instruction generating module, the authorization period information in the first blockchain according to the block identifier and the work identifier, determining whether the authorization period information is greater than the platform authorization period information, and generating, by the exhibition determination instruction generating module, a permission exhibition determination instruction in response to the authorization period information being greater than the platform authorization period information, or generating, by the exhibition determination instruction generating module, a rejection exhibition determination instruction in response to the authorization period information being not greater than the platform authorization period information.

Further, the system also includes a second blockchain processing apparatus, which includes a second blockchain generating and issuing module and a second storage module.

The second blockchain generating and issuing module is configured to construct indicated content information into a block, save the block into a second blockchain, and issue the indicated content information to a network storing the second blockchain. The indicated content information includes the exhibition determination instruction, the work identifier, and exhibition terminal information.

The second storage module is configured to store the work identifier, the exhibition terminal information, and the block identifier of the block where the indicated content information is located.

In an exemplary embodiment, the system also includes a first authentication result processing apparatus, which includes an indicated content information acquiring module, a comparing module, and an indicated content information updating module.

The indicated content information acquiring module is configured to obtain indicated content update information, where the indicated content update information includes the exhibition determination instruction, the work identifier, and the exhibition terminal information.

The comparing module is configured to determine whether the exhibition determination instruction corresponding to the same work identifier and the same exhibition terminal information is changed according to the indicated content update information and the indicated content information, and generate a prompt instruction in response to the exhibition determination instruction being changed.

The indicated content information updating module is configured to update the stored block identifier of the block where the indicated content information is to be a block identifier of a block where a content included in the indicated content update information is located.

In an exemplary embodiment, the system also includes a second authentication result processing apparatus, which includes a query instruction receiving module, a second blockchain block identifier acquiring module, an exhibition determination instruction acquiring module, and an exhibition information generating module.

The query instruction receiving module is configured to obtain a query instruction, which includes a work identifier.

The second blockchain block identifier acquiring module is configured to search, according to the work identifier of the query instruction, the stored exhibition terminal information and the block identifier of the block where the indicated content information is located.

The exhibition determination instruction acquiring module is configured to obtain an exhibition determination instruction in the second blockchain according to the block identifier, the work identifier, and the exhibition terminal information.

The exhibition information generating module is configured to generate exhibition information including the work identifier, the exhibition terminal information, and the exhibition determination instruction.

An embodiment of the present disclosure provides a non-transitory computer-readable storage medium, which stores computer instructions. When the computer instructions are executed, the steps of the above method are performed.

An embodiment of the present disclosure provide a computer device, which includes a memory, a processor, and a computer program stored in the memory and executed by the processor. When the processor executes the program, the steps of the above method are implemented.

Any product or method for implementing the present disclosure does not necessarily have all the foregoing advantages simultaneously. Additional features and advantages of the present disclosure will be set forth in the embodiments of the specification which follows, and in part will be apparent from the embodiments of the specification, or may be learned by implementing the present disclosure. The objectives and other advantages of the present disclosure may be implemented and obtained by structures particularly indicated in the specification, the claims, and the accompanying drawings.

### BRIEF DESCRIPTION OF THE DRAWINGS

The accompanying drawings are provided for further understanding the technical solutions of the present disclosure and constitute a part of the specification, and, together with the embodiments of the present disclosure, are provided to interpret the technical solutions of the present disclosure, rather than limiting the technical solutions of the present disclosure. Shapes and sizes of parts in the accompanying drawings do not reflect true scale thereof, and the objective is merely to schematically illustrate contents of the present disclosure.

FIG. 1 is a schematic diagram of a major structure of a system according to an embodiment of the present disclosure;

FIG. 2 is a flowchart of a method for rights management according to an embodiment of the present disclosure;

FIG. 3 is a schematic diagram of a system for rights management according to an embodiment of the present disclosure;

FIG. 4 is a flowchart of a method for rights management for actively reminding a rights holder of change of an exhibition state according to an embodiment of the present disclosure;

FIG. 5 is a schematic structural diagram of an authentication result processing apparatus for implementing flows in FIG. 4;

FIG. 6 is a flowchart of a method for rights management for actively querying an exhibition state by a rights holder according to an embodiment of the present disclosure;

FIG. 7 is a schematic structural diagram of an authentication result processing apparatus for implementing flows in FIG. 6;

FIG. 8 is a structural diagram of a system for rights management according to an application example 1 of the present disclosure; and

FIG. 9 is a structural diagram of a system for rights management according to an application example 2 of the present disclosure.

### DETAILED DESCRIPTION

In the following, specific implementations of the present disclosure are further described in detail with reference to the accompanying drawings and embodiments. The following embodiments are intended to describe the present disclosure but are not intended to limit the scope of the present disclosure. It is to be noted that the embodiments of this disclosure and the features in the embodiments may be arbitrarily combined with each other in the case of no conflict.

The reasons for the two aforementioned problems, namely, of the platform provider's overdue exhibition or a user's overdue exhibition, are as follows: the platform provider likely tampers with the authorization time information to deceive the digital rights holder, and the digital rights holder cannot supervise the user's playback permission. This leads to impairment of rights and interests of the digital rights holder.

As a decentralized storage and calculation technology, the blockchain generates a persistent and unchangeable record by superimposing encrypted data blocks in time sequence, and stores the record in each blockchain node device of the blockchain. In this regard, distributed data are stored in a decentralized manner. Each data block contains system data within a certain period, and a data “fingerprint” is generated to authenticate the validity of information and to link a next data block. Therefore, the blockchain has technical advantages in data tamper-proofing, transparency, and decentralization, and may record digital rights or related information, ensuring the record results cannot be tampered with. The digital rights or the related information is recorded in a blockchain account book, such that the rights holder may view the digital rights or the related information. In this regard, supervision or control of the playback period is implemented in the phase of executing the playback operation to prevent an illegal user from tampering with the digital rights or the related information.

As shown in FIG. 1, a subject involved in the embodiments of the present disclosure includes a holder of the digital rights (hereinafter referred to as the digital rights holder) of the work, the platform provider, and the terminal user. The digital rights holder uses the rights management client 1 to view the digital rights or the related information. The platform provider uses the rights management client 2 to carry out rights management. The rights management client used by the digital rights holder and the platform management may be the same client, but having different permissions, or may be different clients. The terminal user uses an exhibition terminal to exhibit the work of the digital rights holder online.

In the embodiments of the present disclosure each block in the first blockchain corresponds to one or more works. The digital rights holder sets an authorization period for the work when the work is authorized to the platform provider, and the platform provider generates a block according to the authorization period of the work, and persists the block into the first blockchain. The blocks in the first blockchain are arrayed in time sequence. Excluding the first block, the block header of each block includes a hash value of the previous block and a hash value of this block, such that all the blocks are linked together like a chain. The block body of each block includes identifier information and authorization period information of the work. How to generate blocks and chain the blocks is a technology well known to those skilled in the art, and their detailed descriptions are omitted here.

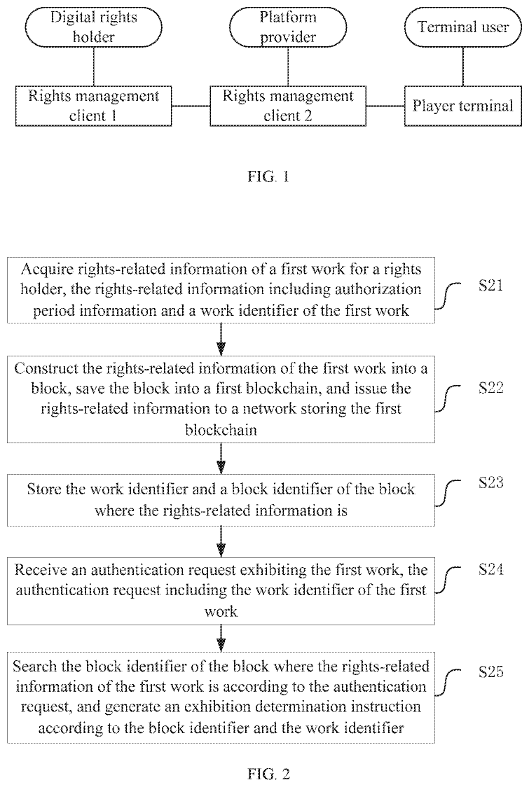

As shown in FIG. 2, the method for rights management of this embodiment includes following steps.

Step 21: acquiring rights-related information of a first work for a rights holder, the rights-related information including authorization period information and a work identifier of the first work.

The rights-related information of the first work for the rights holder may be acquired from a rights management client of a digital rights holder, or may be acquired from an authorization period processing apparatus independent of the rights management client, where the acquirement described herein may be either an active acquirement or a passive acquirement.

The work identifier is used to distinguish each work, and uniquely represents a code of the work, and may be recorded with an author name or a name of the work. The authorization period information of the work may be either time information or number information.

Step 22: constructing the rights-related information of the first work into a block, saving the block into a first blockchain, and issuing the rights-related information to a network storing the first blockchain.

When the blockchain is constructed, the work identifier and the authorization period information corresponding to the work are written into the block body, and then the block header is generated. Information such as a hash value (such as a Merkel root) of this block, a hash value of the previous block and a timestamp is added into the block header, and the block header and the block body are packaged and then are chained. Only after a block containing the rights management-related information is successfully authenticated by a blockchain apparatus in the network, may the block be persisted into the blockchain, thereby completing the issuing operation.

Step 23: storing the work identifier and a block identifier of the block where the rights-related information is.

The block identifier of the block where the rights-related information is located may be block header information or header information for indexing this block on the first blockchain. Specifically, how to index the blockchain to acquire data in the block is a technology well known to those skilled in the art, and the detailed description thereof is omitted here.

Step 24: receiving an authentication request exhibiting the first work, the authentication request including the work identifier of the first work.

The authentication request is sent by an exhibition terminal before online playback. A playback request may be regarded as an authentication request. The authentication request at least carries identification information of a work.

Step 25: searching the block identifier of the block where the rights-related information of the first work is according to the authentication request, and generating an exhibition determination instruction according to the block identifier and the work identifier.

The prestored block identifier of the block where the rights-related information is located, which corresponds to a work identifier in the authentication request, is searched according to the work identifier. Next, the first blockchain is indexed according to the block identifier, and then the authorization period information of the work is searched according to the work identifier. The authorization period information may be number information, for example, the total number of times of permitting the exhibition. When it is determined whether to permit to exhibit the first work to the terminal, it is determined whether to permit to exhibit this work according to whether the total number of times is greater than zero. The exhibition determination instruction is generated if the work is permitted to be exhibited. One is subtracted from the total number of times each time it is permitted to exhibit this work.

In the above management method, the steps 21-23 are first blockchain processing flows, and the steps 24-25 are playback permission authentication flows.

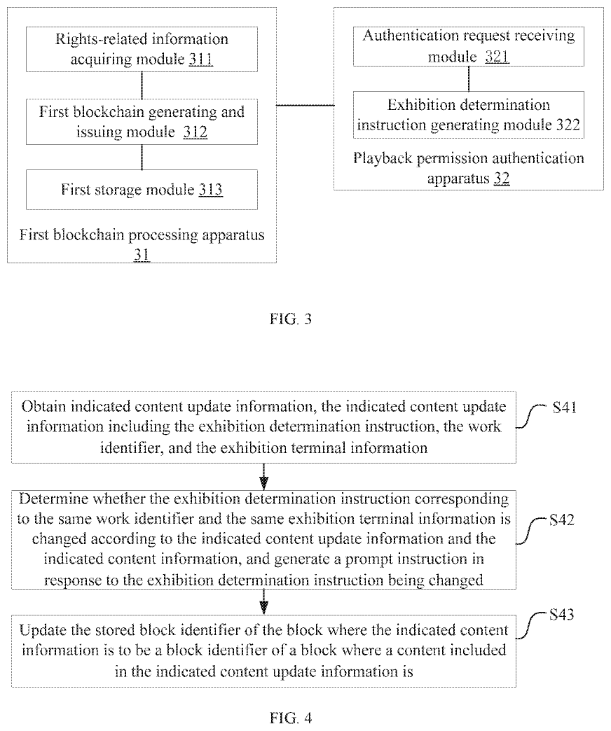

As shown in FIG. 3, a system for rights management for implementing the above method includes a first blockchain processing apparatus 31 and a playback permission authentication apparatus 32. The first blockchain processing apparatus 31 includes a rights-related information acquiring module 311, a first blockchain generating and issuing module 312, and a first storage module 313. The playback permission authentication apparatus 32 includes an authentication request receiving module 321 and an exhibition determination instruction generating module 322.

The rights-related information acquiring module 311 is configured to acquire rights-related information of a first work for a rights holder, where the rights-related information includes authorization period information and a work identifier of the first work.

The first blockchain generating and issuing module 312 is configured to construct the rights-related information of the first work into a block, save the block into a first blockchain, and issue the rights-related information to a network storing the first blockchain.

The first storage module 313 is configured to store a block identifier and the work identifier of the block where the rights-related information is located.

The authentication request receiving module 321 is configured to receive an authentication request exhibiting the first work, where the authentication request includes the work identifier of the first work.

The exhibition determination instruction generating module 322 is configured to search the block identifier of the block where the rights-related information of the first work is located according to the authentication request, and generate an exhibition determination instruction according to the block identifier and the work identifier.

In an alternative embodiment, the first blockchain processing apparatus 31 may include a memory and a processor. The memory is configured to store an application program code supporting the first blockchain processing apparatus to perform the Steps 21-23 of the above method, and the processor is configured to execute application programs stored in the memory. The apparatus may further include a communication interface configured to manage the apparatus to communication with other apparatuses or communication networks.

In an alternative embodiment, the playback permission authentication apparatus 32 may include a memory and a processor. The memory is configured to store an application program code supporting the playback permission authentication apparatus 32 to perform the Steps 24-25 of the above method, and the processor is configured to execute the application programs stored in the memory. The apparatus may further include a communication interface configured to manage the apparatus to communication with other apparatuses or communication networks.

Using the above solution, the authorization period information of the work is saved on the first blockchain, and before each on-line exhibition, it is first determined whether to permit the exhibition according to the authorization period information saved on the first blockchain. In this respect, due to unchangeability of the blockchain, the security of the authorization period information stored on the blockchain is ensured without downloading or storing a license at the player terminal, and thus the flow processing is simpler and more efficient.

In an alternative embodiment, the authentication request also includes platform authorization period information on the first work for a platform provider. The generating an exhibition determination instruction according to the block identifier and the work identifier in the above step specifically includes: obtaining the authorization period information in the first blockchain according to the block identifier and the work identifier, determining whether the authorization period information is greater than the platform authorization period information, and generating a permission exhibition determination instruction in response to the authorization period information being greater than the platform authorization period information, or generating a rejection exhibition determination instruction in response to the authorization period information being not greater than the platform authorization period information.

The authorization period information may be time information, for example, authorization starting time and an authorization duration, or authorization starting time and authorization end time. In this regard, the platform authorization period also corresponds to the time information. When it is determined whether to permit to exhibit the first work to the terminal, it is determined whether the authorization period information is greater than the platform authorization period information. That is, it is determined whether time authorized by a platform to a player is within the period authorized by the digital rights holder to the platform provider, i.e., it is determined whether the platform provider is still entitled to authorize a user to exhibit the work online.

The system as shown in FIG. 3 also may implement the above embodiment. The generating, by the exhibition determination instruction generating module 322, an exhibition determination instruction according to the block identifier and the work identifier includes: obtaining, by the exhibition determination instruction generating module 322, the authorization period information in the first blockchain according to the block identifier and the work identifier, determining whether the authorization period information is greater than the platform authorization period information, and generating, by the exhibition determination instruction generating module, a permission exhibition determination instruction in response to the authorization period information being greater than the platform authorization period information, or generating, by the exhibition determination instruction generating module, a rejection exhibition determination instruction in response to the authorization period information being not greater than the platform authorization period information.

By adopting the above alternative embodiments, the digital rights holder and the platform provider may have more forms for the authorization period of the work, and may prevent the platform provider from expired authorization.

In an alternative embodiment, the above method may also include following steps.

Constructing indicated content information into a block, saving the block into a second blockchain, and issuing the indicated content information to a network storing the second blockchain, where the indicated content information includes the exhibition determination instruction, the work identifier, and exhibition terminal information; and storing the work identifier, the exhibition terminal information, and the block identifier of the block where the indicated content information is located.

The exhibition terminal information includes an identifier of an exhibition terminal, which may be, for example, a terminal machine code. The indicated content information may further include time information, such as online playback time, or the time at which the authentication request is sent. The exhibition determination instruction includes the permission exhibition determination instruction or the rejection exhibition determination instruction.

The work identifier, the exhibition terminal information, and the block identifier of the block where the indicated content information is located are stored for the convenience of subsequent indexing.

The construction process of the second blockchain is similar with that of the first blockchain, and thus its detailed description is omitted here.

The system as shown in FIG. 3 also may implement the above embodiment. Specifically, the system as shown in FIG. 3 also includes a second blockchain processing apparatus 33, which includes a second blockchain generating and issuing module 331 and a second storage module 332.

The second blockchain generating and issuing module 331 is configured to construct indicated content information into a block, save the block into a second blockchain, and issue the indicated content information to a network storing the second blockchain. The indicated content information includes the exhibition determination instruction, the work identifier, and exhibition terminal information.

The second storage module 332 is configured to store the work identifier, the exhibition terminal information, and the block identifier of the block where the indicated content information is located.

In an alternative embodiment, the second blockchain processing apparatus 33 may include a memory and a processor. The memory is configured to store an application program code supporting the second blockchain processing apparatus to perform the above method, and the processor is configured to execute application programs stored in the memory. The apparatus may further include a communication interface configured to manage the apparatus to communication with other apparatuses or communication networks.

By constructing the second blockchain, the indicated content information including the work identifier, the exhibition terminal information, and the exhibition determination instruction is stored, such that the exhibition determination instruction is prevented from being tampered with. Furthermore, storing the work identifier, the exhibition terminal information, and the block identifier of the block where the indicated content information is located may make it possible for the rights holder to index the second blockchain, which may facilitate the digital rights holder to query the current exhibition state of the work at any moment.

In an alternative embodiment, as shown in FIG. 4, the foregoing method may also include the following steps.

Step 41: obtaining indicated content update information, the indicated content update information including the exhibition determination instruction, the work identifier, and the exhibition terminal information.

When a new block is added into the second blockchain, the indicated content update information may be generated, where the indicated content update information is updated indicated content information.

Step 42: determining whether the exhibition determination instruction corresponding to the same work identifier and the same exhibition terminal information is changed according to the indicated content update information and the indicated content information, and generating a prompt instruction in response to the exhibition determination instruction being changed.

The prestored block identifier of the block where the indicated content information is located, corresponding to the same work identifier and the same exhibition terminal information, is searched for according to the work identifier and the exhibition terminal information in the updated indicated content information. The second blockchain is indexed according to the searched block identifier, such that the exhibition determination instruction corresponding to the same work identifier and the same exhibition terminal information is obtained. The obtained exhibition determination instruction is compared with the exhibition determination instruction in the updated indicated content information to determine whether the obtained exhibition determination instruction is changed. A prompt instruction is generated if the obtained exhibition determination instruction is changed. Otherwise, no prompt instruction is generated. The generated prompt instruction may be sent to a rights management client 1.

Step 43: updating the stored block identifier of the block where the indicated content information is to be a block identifier of a block where a content included in the indicated content update information is.

No matter whether the obtained exhibition determination instruction is changed, after the comparison, the stored block identifier of the block where the indicated content information is updated to be the block identifier of the block where the updated indicated content update information is, for the convenience of next comparison.

The system as shown in FIG. 3 also may implement the above embodiment. Specifically, as shown in FIG. 5, the system also includes a first authentication result processing apparatus 51, which includes an indicated content information acquiring module 511, a comparing module 512, and an indicated content information updating module 513.

The indicated content information acquiring module 511 is configured to obtain indicated content update information, where the indicated content update information includes the exhibition determination instruction, the work identifier, and the exhibition terminal information.

The comparing module 512 is configured to determine whether the exhibition determination instruction corresponding to the same work identifier and the same exhibition terminal information is changed according to the indicated content update information and the indicated content information, and generate a prompt instruction in response to the exhibition determination instruction being changed.

The indicated content information updating module 513 is configured to update the stored block identifier of the block where the indicated content information is located to be a block identifier of a block where a content included in the indicated content update information is located.

In an alternative embodiment, the first authentication result processing apparatus 51 may include a memory and a processor. The memory is configured to store an application program code supporting the first authentication result processing apparatus to perform the method for rights management as shown in FIG. 4, and the processor is configured to execute application programs stored in the memory. The apparatus may further include a communication interface configured to manage the apparatus to communication with other apparatuses or communication networks.

Through the above solution, for the same work and the same exhibition terminal, if the exhibition determination instruction is changed, this indicates that the exhibition state is changed. To prevent an unauthorized exhibition, there is provided a solution to take the initiative to report the exhibition state change to the digital rights holder when the exhibition state is changed. By adopting a mechanism of automatically comparing and automatic reporting, it is convenient for the digital rights holder to acquire the exhibition state change in time, which may assist the digital rights holder to monitor the exhibition state, further strengthen the supervision over the platform provider and the terminal user, and provide powerful protection for the digital rights holder.

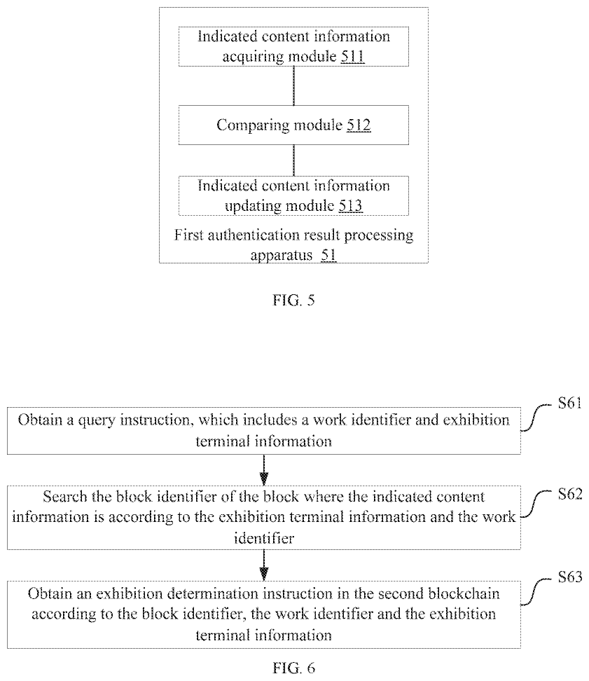

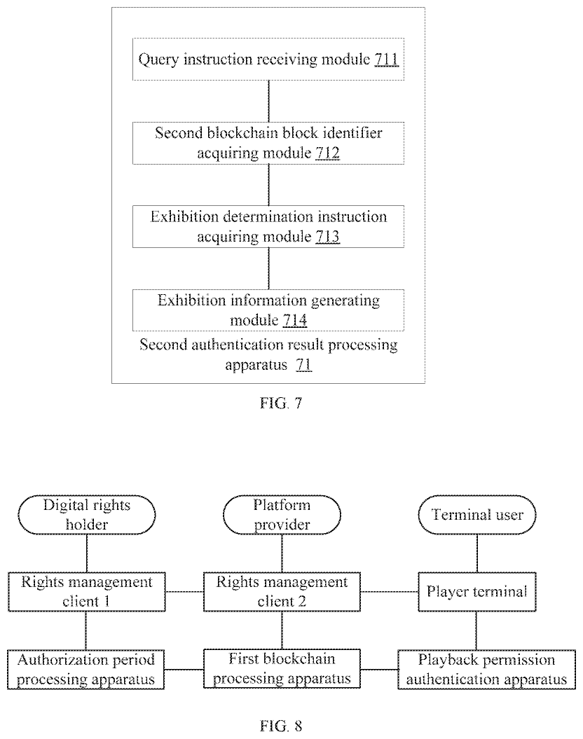

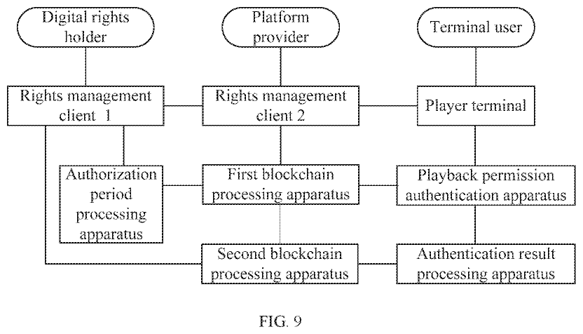

In an alternative embodiment, as shown in FIG. 6, the foregoing method may also include the following steps.

Step 61: obtaining a query instruction, which includes a work identifier.

The query instruction may be sent by the digital rights holder via the rights management client 1.

Step 62: searching the stored exhibition terminal information and the block identifier of the block where the indicated content information is according to the work identifier of the query instruction.

Step 63: obtaining an exhibition determination instruction in the second blockchain according to the block identifier, the work identifier, and the exhibition terminal information.

The second blockchain may be indexed according to the block identifier, and the corresponding exhibition determination instruction may be obtained according to the work identifier and the exhibition terminal information.

Step 64: generating exhibition information including the work identifier, the exhibition terminal information, and the exhibition determination instruction.

The exhibition information will be sent to an apparatus for sending a query instruction.

The system as shown in FIG. 3 also may implement the above embodiment. Specifically, the system also includes a second authentication result processing apparatus 71, which includes a query instruction receiving module 711, a second blockchain block identifier acquiring module 712, an exhibition determination instruction acquiring module 713, and an exhibition information generating module 714.

The query instruction receiving module 711 is configured to obtain a query instruction, which includes a work identifier.

The second blockchain block identifier acquiring module 712 is configured to search, according to the work identifier of the query instruction, the stored exhibition terminal information and the block identifier of the block where the indicated content information is located.

The exhibition determination instruction acquiring module 713 is configured to obtain an exhibition determination instruction in the second blockchain according to the block identifier, the work identifier, and the exhibition terminal information.

The exhibition information generating module 714 is configured to generate exhibition information including the work identifier, the exhibition terminal information, and the exhibition determination instruction.

In an alternative embodiment, the second authentication result processing apparatus 71 may include a memory and a processor. The memory is configured to store an application program code supporting the second authentication result processing apparatus 71 to perform the method for rights management as shown in FIG. 6, and the processor is configured to execute application programs stored in the memory. The apparatus may further include a communication interface configured to manage the apparatus to communication with other apparatuses or communication networks.

Using the above solution, a channel for active query is provided for the digital rights holder, such that the digital rights holder can timely understand the playback situation and popularity of the work. In one aspect, the platform provider and users may be supervised to protect the rights of the digital rights holder. In another aspect, it is convenient for a creator to deal with according to the popularity, for example, to increase the price of permission exhibition rights and/or the price of the exhibition rights, or whether to perform subsequent creation. The above contents recorded are for example only, and information may be recorded according to the needs of the digital rights holder. The more the information is recorded, the more detailed the contents obtained by the digital rights holder.

The first authentication result processing apparatus 51 and the second authentication result processing apparatus 71 may either coexist or not coexist.

### Application Example 1

In this example, the digital rights holder may authorize the exhibition rights and the permission exhibition rights of the work to the platform provider, and may set the authorization period. The rights management client 2 obtains the authorization period information of the digital rights holder, packages and writes the authorization period information into the first blockchain, and issues the first blockchain to the network. The authorization period information of the digital rights holder to the platform provider also may be sent by a separate authorization period processing apparatus to the rights management client 1, and packaging and chaining the authorization period information also may be completed by a separate first blockchain processing apparatus. As shown in FIG. 8, the authorization period processing apparatus is connected to the first blockchain processing apparatus to transmit the authorization period and the authorized content to the first blockchain processing apparatus.

The authorization period processing apparatus may perform hash operation on the digital content according to a certain hash algorithm to obtain a digital content hash value, and then perform hash operation on the digital content hash value and an address of the current digital rights holder according to a certain hash algorithm to obtain a digital content ID, i.e., the digital content ID=hash (the digital content hash value+the address of the digital rights holder). There are a variety of hash algorithms, for example, a secure hash algorithm (SHA1) and a message-digest algorithm 5 (MD5). In this example, the digital content includes the authorization period information of the digital rights holder. The address of the digital rights holder is generated by a key through a certain operation. The address may be a key, a hash value of the key, or a script containing the key and an operating instruction. Specifically, the address of the digital rights holder is a script composed of the key of the digital rights holder and the operating instruction generating the authorization period. The address of the digital rights holder corresponds to the key of the digital rights holder+authorization period, and is ensured to be unique in the entire network. The address of the digital rights holder may be pre-generated, and a terminal user has an address when registering with a player terminal.

Whereafter, the platform provider authorizes the exhibition rights of the work to the terminal user. The terminal user purchases the player terminal provided by the platform provider, and the platform provider sets a playback rule in the player terminal. The authorization period should be authenticated before playing the work of the digital rights holder. The terminal user operates the player terminal to play the work of the digital rights holder on line. The player terminal sends an authentication request exhibiting the work to the playback permission authentication apparatus 32, and the playback permission authentication apparatus 32 sends the authentication request exhibiting the work to the first blockchain processing apparatus 31. The first blockchain processing apparatus 31 indexes the first blockchain according to the authentication request, and queries the digital rights holder of the work to be exhibited and the authorization period content of the platform provider. The first blockchain processing apparatus 31 transmits the authorization period information to the playback permission authentication apparatus 32, such that the playback permission authentication apparatus 32 calculates whether it is currently within the authorization period according to the authorization period information, and controls the player terminal to play the work if it does not exceed the authorization period. Otherwise, the playback permission authentication apparatus 32 reminds the terminal of exceeding the authorization period, and the player terminal does not play the work.

The first blockchain processing apparatus 31 may be arranged separately or may be arranged in combination with the rights management client 2. The playback permission authentication apparatus 32 may be arranged separately or may be arranged in combination with the player terminal.

### Application Example 2

Based on the application example 1, the playback permission authentication apparatus 32 calculates whether it is currently within the authorization period according to the authorization period information. After the exhibition determination instruction (permitting the playback or refusing the playback) is obtained, as shown in FIG. 5, the playback permission authentication apparatus 32 or the player terminal transmits, to the authentication result processing apparatus, the exhibition determination instruction indicating that the playback is permitted or not. The second blockchain processing apparatus 33 acquires, via the authentication result processing apparatus, the exhibition determination instruction authenticated by the first blockchain processing apparatus 31 and the playback permission authentication apparatus 32, packages and writes the indicated content information containing the exhibition determination instruction into the second blockchain, and issues the second blockchain to the network. The indicated content information includes, for example, a terminal identifier requesting to exhibit a work, a work identifier of the work, and an exhibition determination instruction (a result of permitting or not permitting the playback). In addition, the second blockchain may further include a block identifier (the address of the block, also referred to as block header information, or header information, or height information) of the work in the first blockchain. Alternatively, the second blockchain may further include time information, which may be check time or time at which the player terminal exhibits the work. Through the second blockchain, the platform provider is prevented from tampering with information in the first private blockchain by virtue of billing rights.

A comparator may be separately arranged in the authentication result processing apparatus. The comparator records three items of contents, i.e., a machine code of the player terminal, work identifier information, and the block header information, of the authentication result (such as the exhibition determination instruction) of the work requested by the player terminal to play back, in the second blockchain. Each time a new block is written to the second blockchain, the comparator traverses the machine code of the player terminal and the work identifier information, searches for the last-recorded block header information, of the authentication result of the work requested by the player terminal to play back, in the second blockchain, indexes the second blockchain according to the searched block header information to find the corresponding block, acquires authentication result information indicating whether to permit the playback according to the machine code of the player terminal and the work identifier information, and compares the acquired authentication result information with authentication result information newly written into the block. If there is a difference, the machine code of the player terminal, the work identifier information and playback status information are transmitted to the rights management client 1 for display to prompt the digital rights holder. Meanwhile, the corresponding block header information in the comparator is updated to ensure that what is stored in the comparator is the block header information, of the latest authentication result of the same work requested by the same player terminal to play back, in the second blockchain.

### Application Example 3

Based on the application example 1 or the application example 2, an apparatus for monitoring the first blockchain may be additionally arranged on the first blockchain processing apparatus to monitor whether the platform provider changes an algorithm of the first blockchain. If the blockchain calculation method is changed, a private blockchain algorithm monitoring apparatus sends a message to the rights management client 1 to remind the digital rights holder of an illegal behavior of the platform provider.

In addition, the first blockchain processing apparatus also may be a monitoring module based on a third party. After the digital rights holder and the platform provider agree on the authorization period, the calculation method of the first blockchain may be packaged in such a way that the algorithm content cannot be changed.

Both the first blockchain processing apparatus 31 and the second blockchain processing apparatus 33 are blockchain nodes.

An embodiment of the present disclosure also provides a computer storage medium, wherein the computer storage medium stores a computer program, and after the computer program is executed, the foregoing method for rights management provided by one or more embodiments may be implemented.

An embodiment of the present disclosure also provides a computer device, which includes a memory, a processor, and a computer program stored on the memory and executable on the processor. When the processor executes the computer program, the foregoing method for rights management provided by one or more embodiments can be implemented.

The generation, encryption, decryption, signature, and authentication of the blockchain in the foregoing embodiments may be performed by using methods in the prior art, which is not described in the embodiments of the present disclosure. Those skilled in the art may know how to perform related processing according to the prior art.

Those of ordinary skill in the art may understand that functional modules/units in all or some steps, systems or apparatuses in the method disclosed above may be implemented by software, firmware, hardware or any suitable combination thereof. In a hardware implementation, the division between functional modules/units mentioned in the above description does not necessarily correspond to the division of physical components. For example, one physical component may have multiple functions, or one function or step may be jointly performed by a plurality of physical components. Some or all the components may be implemented as software executed by a processor such as a digital signal processor or microprocessor, or may be implemented as hardware or an integrated circuit such as an application specific integrated circuit. Such software may be distributed on a computer readable medium, which may include a computer storage medium (or non-transitory storage medium) and a communication medium (or a transitory medium). As well known to those of ordinary skill in the art, the term computer storage media include volatile and nonvolatile, removable and non-removable media implemented in any method or technology for storage of information, such as computer readable instructions, data structures, program modules, or other data. The computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computer. Furthermore, as well known to those of ordinary skill in the art, communication media typically include computer-readable instructions, data structures, program modules or other data in a modulated data signal such as a carrier wave or other transport mechanism, and may include any information delivery media.

The above are embodiments disclosed by the present disclosure. However, the described contents are merely embodiments adopted for better understanding the present disclosure rather than limiting the present disclosure. Any person skilled in the art can make any modification and variation to the implementing forms or details without departing from the spirit and scope of the present disclosure. However, the patent protection scope of the present disclosure should still be subjected to the scope defined in the appended claims.

1. A method for rights management comprising:
acquiring rights-related information of a first work for a rights holder, the rights-related information comprising authorization period information and a work identifier of the first work;
constructing the rights-related information of the first work into a block, saving the block into a first blockchain, and issuing the rights-related information to a network storing the first blockchain;
storing the work identifier and a block identifier on the block where the rights-related information is located;
receiving an authentication request exhibiting the first work, the authentication request comprising the work identifier of the first work; and
searching the block identifier of the block where the rights-related information of the first work is located according to the authentication request, and generating an exhibition determination instruction according to the block identifier and the work identifier.

2. The method for rights management according to claim 1, wherein:
the authentication request further comprises platform authorization period information on the first work for a platform provider;
the generating an exhibition determination instruction according to the block identifier and the work identifier comprises:
obtaining the authorization period information in the first blockchain according to the block identifier and the work identifier,
determining whether the authorization period information is greater than the platform authorization period information, and
generating a permission exhibition determination instruction in response to the authorization period information being greater than the platform authorization period information, or
generating a rejection exhibition determination instruction in response to the authorization period information being not greater than the platform authorization period information.

3. The method for rights management according to claim 1, further comprising:
constructing indicated content information into a block, saving the block into a second blockchain, and issuing the indicated content information to a network storing the second blockchain, the indicated content information comprising the exhibition determination instruction, the work identifier, and exhibition terminal information; and
storing the work identifier, the exhibition terminal information, and the block identifier of the block where the indicated content information is located.

4. The method for rights management according to claim 2 further comprising:
constructing indicated content information into a block, saving the block into a second blockchain, and issuing the indicated content information to a network storing the second blockchain, the indicated content information comprising the exhibition determination instruction, the work identifier, and exhibition terminal information; and
storing the work identifier, the exhibition terminal information, and the block identifier of the block where the indicated content information is located.

5. The method for rights management according to claim 3 further comprising:
obtaining indicated content update information, the indicated content update information comprising the exhibition determination instruction, the work identifier, and the exhibition terminal information;
determining whether the exhibition determination instruction corresponding to the same work identifier and the same exhibition terminal information is changed according to the indicated content update information and the indicated content information, and generating a prompt instruction in response to the exhibition determination instruction being changed; and
updating the stored block identifier of the block where the indicated content information is to be a block identifier of a block where a content comprised in the indicated content update information is located.

6. The method for rights management according to claim 3 further comprising:
obtaining a query instruction comprising a work identifier;
searching the stored exhibition terminal information and the block identifier of the block where the indicated content information is according to the work identifier of the query instruction;
obtaining an exhibition determination instruction in the second blockchain according to the block identifier, the work identifier and the exhibition terminal information; and
generating exhibition information comprising the work identifier, the exhibition terminal information and the exhibition determination instruction.

7. A system for rights management, comprising:
a first blockchain processing apparatus and a playback permission authentication apparatus, the first blockchain processing apparatus comprising:
a rights-related information acquiring module,
a first blockchain generating and issuing module, and
a first storage module, and
the playback permission authentication apparatus comprising an authentication request receiving module and an exhibition determination instruction generating module, wherein:
the rights-related information acquiring module is configured to acquire rights-related information of a first work for a rights holder, the rights-related information comprising authorization period information and a work identifier of the first work;
the first blockchain generating and issuing module is configured to construct the rights-related information of the first work into a block, save the block into a first blockchain, and issue the rights-related information to a network storing the first blockchain;
the first storage module is configured to store the work identifier and a block identifier of the block where the rights-related information is located;
the authentication request receiving module is configured to receive an authentication request exhibiting the first work, the authentication request comprising the work identifier of the first work; and
the exhibition determination instruction generating module is configured to search the block identifier of the block where the rights-related information of the first work is according to the authentication request, and generate an exhibition determination instruction according to the block identifier and the work identifier.

8. The system according to claim 7, wherein:
the authentication request further comprises platform authorization period information on the first work for a platform provider;
the generating, by the exhibition determination instruction generating module, an exhibition determination instruction according to the block identifier and the work identifier comprises:
obtaining, by the exhibition determination instruction generating module, the authorization period information in the first blockchain according to the block identifier and the work identifier, determining whether the authorization period information is greater than the platform authorization period information, and
generating, by the exhibition determination instruction generating module, a permission exhibition determination instruction in response to the authorization period information being greater than the platform authorization period information, or
generating, by the exhibition determination instruction generating module, a rejection exhibition determination instruction in response to the authorization period information being not greater than the platform authorization period information.

9. The system according to claim 7, wherein the system further comprises a second blockchain processing apparatus comprising a second blockchain generating and issuing module and a second storage module, wherein:
the second blockchain generating and issuing module is configured to construct indicated content information into a block, save the block into a second blockchain, and issue the indicated content information to a network storing the second blockchain, the indicated content information comprising the exhibition determination instruction, the work identifier, and exhibition terminal information; and
the second storage module is configured to store the work identifier, the exhibition terminal information, and the block identifier of the block where the indicated content information is located.

10. The system according to claim 8, wherein the system further comprises a second blockchain processing apparatus comprising a second blockchain generating and issuing module and a second storage module, wherein:
the second blockchain generating and issuing module is configured to construct indicated content information into a block, save the block into a second blockchain, and issue the indicated content information to a network storing the second blockchain, the indicated content information comprising the exhibition determination instruction, the work identifier, and exhibition terminal information; and
the second storage module is configured to store the work identifier, the exhibition terminal information, and the block identifier of the block where the indicated content information is located.

11. The system according to claim 9, wherein the system further comprises a first authentication result processing apparatus comprising an indicated content information acquiring module, a comparing module, and an indicated content information updating module, wherein:
the indicated content information acquiring module is configured to obtain indicated content update information, the indicated content update information comprising the exhibition determination instruction, the work identifier, and the exhibition terminal information;
the comparing module is configured to determine whether the exhibition determination instruction corresponding to the same work identifier and the same exhibition terminal information is changed according to the indicated content update information and the indicated content information, and generate a prompt instruction in response to the exhibition determination instruction being changed; and
the indicated content information updating module is configured to update the stored block identifier of the block where the indicated content information is to be a block identifier of a block where a content comprised in the indicated content update information is located.

12. The system according to claim 10, wherein the system further comprises a first authentication result processing apparatus comprising an indicated content information acquiring module, a comparing module, and an indicated content information updating module, wherein:
the indicated content information acquiring module is configured to obtain indicated content update information, the indicated content update information comprising the exhibition determination instruction, the work identifier, and the exhibition terminal information;
the comparing module is configured to determine whether the exhibition determination instruction corresponding to the same work identifier and the same exhibition terminal information is changed according to the indicated content update information and the indicated content information, and generate a prompt instruction in response to the exhibition determination instruction being changed; and
the indicated content information updating module is configured to update the stored block identifier of the block where the indicated content information is to be a block identifier of a block where a content comprised in the indicated content update information is located.

13. The system according to claim 9, wherein the system further comprises a second authentication result processing apparatus comprising a query instruction receiving module, a second blockchain block identifier acquiring module, an exhibition determination instruction acquiring module and an exhibition information generating module, wherein:
the query instruction receiving module is configured to obtain a query instruction comprising a work identifier;
the second blockchain block identifier acquiring module is configured to search, according to the work identifier of the query instruction, the stored exhibition terminal information and the block identifier of the block where the indicated content information is located;
the exhibition determination instruction acquiring module is configured to obtain an exhibition determination instruction in the second blockchain according to the block identifier, the work identifier and the exhibition terminal information; and
the exhibition information generating module is configured to generate exhibition information comprising the work identifier, the exhibition terminal information and the exhibition determination instruction.

14. The system according to claim 10, wherein the system further comprises a second authentication result processing apparatus comprising a query instruction receiving module, a second blockchain block identifier acquiring module, an exhibition determination instruction acquiring module and an exhibition information generating module, wherein:
the query instruction receiving module is configured to obtain a query instruction comprising a work identifier;
the second blockchain block identifier acquiring module is configured to search, according to the work identifier of the query instruction, the stored exhibition terminal information and the block identifier of the block where the indicated content information is located;
the exhibition determination instruction acquiring module is configured to obtain an exhibition determination instruction in the second blockchain according to the block identifier, the work identifier and the exhibition terminal information; and
the exhibition information generating module is configured to generate exhibition information comprising the work identifier, the exhibition terminal information and the exhibition determination instruction.

15. A non-transitory computer readable storage medium, storing a computer program comprising program instructions that, when executed, direct at least one computing device to:
acquire rights-related information of a first work for a rights holder, the rights-related information comprising authorization period information and a work identifier of the first work;
construct the rights-related information of the first work into a block;
save the block into a first blockchain;
issue the rights-related information to a network storing the first blockchain;
store the work identifier and a block identifier on the block where the rights-related information is located;
receive an authentication request exhibiting the first work, the authentication request comprising the work identifier of the first work;
search the block identifier of the block where the rights-related information of the first work is located according to the authentication request, and
generate an exhibition determination instruction according to the block identifier and the work identifier.

16. The non-transitory computer readable storage medium according to claim 15, wherein:
the authentication request further comprises platform authorization period information on the first work for a platform provider;
the generating the exhibition determination instruction according to the block identifier and the work identifier comprises:
obtaining the authorization period information in the first blockchain according to the block identifier and the work identifier;
determining whether the authorization period information is greater than the platform authorization period information; and
generating a permission exhibition determination instruction in response to the authorization period information being greater than the platform authorization period information; or
generating a rejection exhibition determination instruction in response to the authorization period information being not greater than the platform authorization period information.

17. The non-transitory computer readable storage medium according to claim 15, wherein the computing device is further directed to:
construct indicated content information into a block;
save the block into a second blockchain;
issue the indicated content information to a network storing the second blockchain, the indicated content information comprising the exhibition determination instruction, the work identifier, and exhibition terminal information; and
store the work identifier, the exhibition terminal information, and the block identifier of the block where the indicated content information is located.

18. The system according to claim 7, further comprising a computing device comprising a memory, a processor, and a computer program stored in the memory and executed by the processor, wherein the at least one computing device comprises the first blockchain processing apparatus or the playback permission authentication apparatus.

19-20. (canceled)
